(19) United States
(12) Patent Application Publication
(10) Pub. No.: US 2012/0004757 A1
(43) Pub. Date: Jan. 5, 2012

(54) OPTIMIZATION DEVICE

(75) Inventors: Hiroyuki Imanari, Chiba (JP); Kazutoshi Kitagoh, Saitama (JP)

(73) Assignee: TOSHIBA MITSUBISHI-ELECTRIC INDUS. SYS. CORP., Tokyo (JP)

(21) Appl. No.: 13/256,281

(22) PCT Filed: Mar. 13, 2009
(86) PCT No.: PCT/JP2009/054915

§ 371 Date: Sep. 13, 2011

(51) Int. Cl. G05B 13/04

(52) U.S. Cl. 700/104

(57) ABSTRACT

A certain embodiment includes a setting calculator (31), an energy use calculator (32), a manufacturing carbon dioxide emission amount calculator (33), and an optimizer (35). The setting calculator (31) operates to depend on an initial size, an initial temperature, and a target temperature of a rolling material (120), to calculate a control setting value for services of a hot rolling mill (100) to mill the rolling material (120). The energy use calculator (32) operates to depend on a control setting value, to calculate a use of energy as a necessary energy for services of the hot rolling mill (100) to mill the rolling material (120). The manufacturing carbon dioxide emission amount calculator (33) operates to depend on a carbon dioxide emission coefficient and a use of energy, to calculate an emission amount of carbon dioxide emitted at the hot rolling mill (100). The optimizer (35) operates to calculate a target temperature to be a temperature equal to or higher than a requisite temperature for the rolling material (120) to be milled with a secured quality, as a temperature to minimize either or both of use of energy and emission amount of manufacturing carbon dioxide.

### FIELD

Embodiments herein relate to optimization devices addressing control of rolling mill, for optimization to be implemented with minimization in amount of either or both of used energy and emitted carbon dioxide, affording to secure product qualities of rolling materials, when milling the rolling materials.

### BACKGROUND

There are rolling facilities for rolling metallic materials, encompassing hot sheet rolling mills, plate rolling mills, and cold rolling mills for manufacturing steel or iron plates (referred herein to as steel plates), rolling mills for steel or iron sections, rolling mills for steel bars or wire rods, and aluminum or copper rolling facilities.

For instance, there are hot sheet rolling mills for services to have a cuboid steel or iron material called slab heated at a slab reheating furnace, up to 1,200° C. or near, and rough rolled at a rough mill into a bar with a thickness within 30 to 40 mm or near. In some cases, there is use of a bar heater to increase bar temperature. Afterward, those hot sheet rolling mills provide services to roll such a rough-rolled bar into a thickness within 1.2 to 12 mm at a finish mill. This bar undergoes subsequent services of the hot sheet rolling mills, where it is cooled down to 700 to 500° C. or near at a water cooling machine, and finally wound up as a coil on a collet As is apparent, the slab is called by different names, such as bar and coil, as it travels respective rolling processes, while they will be collectively referred herein to as a rolling material.

Such being the case, hot sheet rolling mills are due to transfer rolling materials, heating at a reheating furnace, and large deforming at rolling mills, thus consuming remarkable energy.

To this point, as energy saving measures generally taken, there are energy saving methods implemented to reduce roll revolution speeds, for instance, while either rolling mill is out of rolling service, that is, during idle time. Further, at rolling mills making use of large volumes of water, hydraulic system oil, and blower air, there are well known energy saving methods implemented to save energy by way of, among others, a number control or start stop control of pumps serving to supply water, oil, or air to the rolling mills.

Further, there is a reheating furnace combustion control method proposed in Patent literature 1 (JP 2005-48202 A) introducing the concept of energy cost to suppress energy cost to a minimum for energy saving operations at reheating furnaces.

On the other hand, there are recent global environmental issues dealt or concerned with increasing attentions, followed by all enterprises, inclusive of steel making companies, handling countermeasures for reducing greenhouse gasses typified by carbon dioxide.

Patent Literature 1: JP 2005-48202 A

### SUMMARY

### Technical Problem

However, there are insufficient effects proven in reduction of energy used and carbon oxide emission, with, among others, the energy saving methods of reducing roll revolution speeds or the energy saving methods by way of pump control. The reheating furnace combustion control method described in Patent literature 1 addresses a countermeasure for energy saving reheating furnaces, and has a difficulty to get a significant energy saving effect in a whole rolling mill, besides deficient consideration to product qualities of rolling materials, that may lead to manufacturing non-conforming goods.

Embodiments herein have been devised in view of such issues, with an object to provide an optimization device adapted for optimization of a rolling mill to minimize either or both of use of energy and emission amount of carbon dioxide, allowing for a secured product quality of rolling materials.

### Solution to Problem

To achieve the object described, according to a first aspect of embodiment, there is an optimization device comprising a setting calculator configured to depend on an initial size, an initial temperature, and a target temperature of a rolling material, to calculate a control setting value for services of a rolling mill to mill the rolling material, an energy use calculator configured to depend on the control setting value calculated at the setting calculator, to calculate a use of energy as necessary energy for services of the rolling mill to mill the rolling material, a manufacturing carbon dioxide emission amount calculator configured to depend on a carbon dioxide emission coefficient and the use of energy calculated at the energy use calculator, to calculate an emission amount of carbon dioxide emitted at the rolling mill, and an optimizer configured to calculate the target temperature to be a temperature equal to or higher than a requisite temperature for the rolling material to be milled with a secured quality, as a temperature to minimize either or both of the use of energy and the emission amount of carbon dioxide.

To achieve the object described, according to a second aspect of embodiment, in the optimization device, the optimizer is configured to calculate a target temperature or target temperatures of the rolling material at one or more out of an entry and an exit of a finish mill adapted for services to finish mill the rolling material, and an entry of a coiler adapted for services to coil the rolling material as finish milled, in the rolling mill.

To achieve the object described, according to a third aspect of embodiment, there is an optimization device comprising a setting calculator configured to depend on an initial size, an initial temperature, and a set of target temperatures of a rolling material, to have a set of control setting values calculated every target temperature for services of a rolling mill to mill the rolling material, an energy use calculator configured to depend on the set of control setting values calculated at the setting calculator, to have a set of uses of energy calculated every control setting value as necessary energy for services of the rolling mill to mill the rolling material, a manufacturing carbon dioxide emission amount calculator configured to depend on a carbon dioxide emission coefficient and the set of uses of energy calculated at the energy use calculator, to have a set of emission amounts of carbon dioxide emitted at the rolling mill calculated every use of energy, and an energy and quality selective renderer configured to render on a display the set of uses of energy and the set of emission amounts of carbon dioxide as calculated, and depend on a selective one of combinations of use of energy and emission amount of carbon dioxide as rendered, to select one out of the set of target temperatures.

To achieve the object described, according to a fourth aspect of embodiment, in the optimization device, the energy and quality selective renderer is configured to select one out of the set of target temperatures at each of one or more out of an entry and an exit of a finish mill adapted for services to finish mill the rolling material, and an entry of a coiler adapted for services to coil the rolling material as finish milled, in the rolling mill.

To achieve the object described, according to a fifth aspect of embodiment, the optimization device comprises the setting calculator being configured for use of a temperature model adapted for calculation of heat balance of the rolling material residing in the rolling mill, to depend on the control setting value as calculated, to calculate a temperature of the rolling material residing in the rolling mill, further comprising a material quality predictor configured to depend on the temperature calculated at the setting calculator, to determine a material quality of the rolling material, the optimizer being configured to calculate the target temperature as a temperature minimizing either or both of the use of energy and the emission amount of carbon dioxide, having the material quality determined at the material quality predictor as a material quality better than preset

To achieve the object described, according to a sixth aspect of embodiment, in the optimization device, the material quality predictor is configured to calculate the material quality as a set of one or more out of tensile strength, yield stress, and ductility of the rolling material as rolled at the temperature of the rolling material calculated at the setting calculator.

To achieve the object described, according to a seventh aspect of embodiment, the optimization device comprises the setting calculator being configured for use of a temperature model adapted for calculation of heat balance of the rolling material residing in the rolling mill, to depend on the set of control setting values as calculated, to calculate a set of temperatures of the rolling material residing in the rolling mill, further comprising a material quality predictor configured to depend on the set of temperatures calculated at the setting calculator, to determine a set of material qualities of the rolling material, the energy and quality selective renderer being configured to render on the display the set of uses of energy and the set of emission amounts of carbon dioxide as calculated, and the set of material qualities as determined, and depend on a selective one of combinations of use of energy, emission amount of carbon dioxide, and material quality as rendered, to select one out of the set of target temperatures.

To achieve the object described, according to an eighth aspect of embodiment, in the optimization device, the material quality predictor is configured to calculate the material quality as a set of one or more out of tensile strength, yield stress, and ductility of the rolling material as rolled at the set of temperatures of the rolling material calculated at the setting calculator.

To achieve the object described, according to a ninth aspect of embodiment, the optimization device further comprises an energy use learner configured to depend on a measure of an electric energy meter or a fuel supply flow meter provided to the rolling mill, to calculate an amount of energy used for services of the rolling mill to mill the rolling material, as an actual use of energy, and depend on the actual use of energy as calculated, to correct a use of energy calculated at the energy use calculator.

To achieve the object described, according to a tenth aspect of embodiment, there is an optimization device comprising a setting calculator configured to depend on an initial size, an initial temperature, and a target temperature of a rolling material, to calculate a control setting value for services of a rolling mill to mill the rolling material, an energy use calculator configured to depend on the control setting value calculated at the setting calculator, to calculate a use of energy as necessary energy for services of the rolling mill to mill the rolling material, a manufacturing carbon dioxide emission amount calculator configured to depend on a carbon dioxide emission coefficient and the use of energy calculated at the energy use calculator, to calculate a product carbon dioxide emission amount as an emission amount of carbon dioxide emitted at the rolling mill, a reference life cycle memory configured to store therein, for each type of associated rolling materials, a reference life cycle as combination of a condition of use for an associated rolling material to be used after shipment, and an amount of carbon dioxide to be emitted in a life cycle thereof including a shipment followed by a collection and a re-milling at the rolling mill, as associated with each other, a product life cycle carbon dioxide emission amount calculator configured to depend on the reference life cycle, to calculate a product life cycle carbon dioxide emission amount as an amount of carbon dioxide emitted in a life cycle of the rolling material manufactured on a basis of the control setting value calculated at the setting calculator, and a carbon dioxide emission amount renderer configured to render on a display the product carbon dioxide emission amount and the product life cycle carbon dioxide emission amount.

### Advantageous Effects

According to certain embodiments herein, there can be an optimized control of rolling mill with minimization of either or both of a use of energy and an emission amount of carbon dioxide, allowing for a secured product quality of rolling materials.

### BRIEF DESCRIPTION OF DRAWINGS

FIG. 1 is a configuration diagram showing configuration of a hot rolling system having applied thereto an optimization device according to a first embodiment.

FIG. 2 is a configuration diagram showing configuration of a CPU provided in the optimization device according to the first embodiment.

FIG. 3 is a flowchart of processes to be implemented at the optimization device according to the first embodiment.

FIG. 4 is a diagram showing a categorization of energy use items calculated by an energy use calculator provided in the CPU at the optimization device according to the first embodiment.

FIG. 5 is a combination of illustrations describing a method of calculating an atmosphere temperature raising energy at the energy use calculator provided in the CPU of the optimization device according to the first embodiment; (a) is an illustration of rolling materials residing in a slab reheating furnace at a time t1, and (b), an illustration of rolling materials residing in the slab reheating furnace at a time t2 after the time t1.

FIG. 6 is a configuration diagram showing configuration of a CPU provided in an optimization device according to a second embodiment.

FIG. 7 is a configuration diagram showing configuration of a CPU provided in an optimization device according to a third embodiment.

FIG. 8 is a flowchart of process flow to be implemented at the optimization device according to the third embodiment.

FIG. 9 is a configuration diagram showing configuration of a CPU provided in an optimization device according to a fifth embodiment.

FIG. 10 is a configuration diagram showing configuration of a CPU provided in an optimization device according to a fifth embodiment.

FIG. 11 is a diagram describing data calculation methods for study of energy use calculation models at an energy use learner provided to a CPU in an optimization device according to a fifth embodiment.

FIG. 12 is a diagram showing a life cycle of rolling materials once shipped, and afterward, collected, and re-milled at a hot rolling mill.

FIG. 13 is a configuration diagram showing configuration of a CPU provided in an optimization device according to a sixth embodiment.

### DETAILED DESCRIPTION

There will be described optimization devices according to embodiments, with reference to the drawings.

### First Embodiment

### <Configuration>

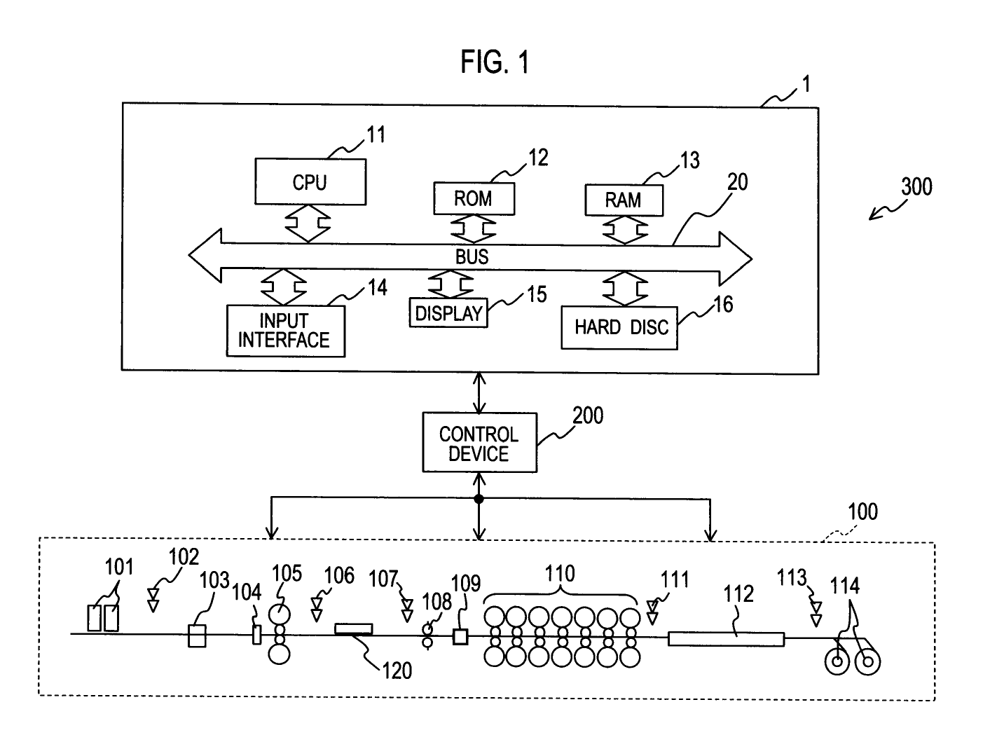

FIG. 1 is a configuration diagram showing configuration of a hot rolling system having applied thereto an optimization device according to a first embodiment.

As shown in FIG. 1, there is a hot rolling system 300 including an optimization device 1 according to the first embodiment, a hot rolling mill 100 for milling rolling materials under hot conditions, and a control device 200 for controlling the hot rolling mill 100, the optimization device 1 being connected to the control device 200.

The hot rolling mill 100 includes slab reheating furnaces 101 adapted for combustion of fossil fuel being a heavy oil or natural gas to thereby reheat rolling materials 120, slab reheating furnace exit thermometers 102 for measuring temperatures at exits of the slab reheating furnaces 101, a high-pressure descaler 103 for injecting high-pressure waterjets to a rolling material 120, from above and below, to remove scales at surfaces of the rolling material 120, an edger 104 adapted for pressure application to extend the rolling material 120 in the plate width direction, a rough mill 105 for rough-milling the rolling material 120, rough mill exit thermometers 106 for measuring temperatures at an exit of the rough mill, finish mill entry thermometers 107 for measuring temperatures at an entry of a finish mill 110, a crop shear 108 for cutting a leading and a trailing end of the rolling material 120, a finish mill entry side descaler 109 for removing scales at surfaces of the rolling material 120, the finish mill 110 working for finish-milling the rolling material 120, finish mill exit thermometers 111 for measuring temperatures at an exit of the finish mill 110, a runout laminar spray cooler 112 for cooling the rolling material 120, coiling thermometers 113 for measuring temperatures of rolling materials 120 as cooled through the runout laminar spray cooler 112, and coilers 114 for coiling rolling materials 120.

The control device 200 is adapted to implement combination of a size control and a thermal control of a rolling material 120, as a quality control to provide a rolling material 120 as a product with secured qualities.

The control device 200 implements, as the size control, a set of dimensional controls including a plate thickness control for controlling a plate thickness at a widthwise central part of a rolling material 120, a plate width control for controlling a plate width thereof, a plate crown control for controlling a widthwise distribution of plate thicknesses thereof, and a flatness control for controlling a widthwise extension of the rolling material 120.

Further, the control device 200 implements, as the thermal control, combination of a finish mill exit temperature control for controlling a temperature at the exit of finish mill 110, and a coiling temperature control for controlling temperatures in front of the coilers 114.

There are items of material quality focused herein as those of a rolling material 120, inclusive of the tensile strength, yield stress, and ductility, for instance, being considerably influenced by conditions such as temperatures and deformation amounts in the finish mill 110, and besides, by the cooling on the way from the exit of finish mill 110 to an entry of coiler 114.

When determining product qualities of a rolling material 120, there is importance placed on, among others, the quality control, and a setting calculation for calculating a control setting value or parameter. The setting calculation includes, for instance, initial calculations made before the timings the rolling material 120 gets bitten into the rough mill 105, and into the finish mill 110, to calculate roll gaps and roll speeds of mill rolls in advance, thereby allowing for a secured stable transfer of the plate. There should be initial settings of cooling water at the finish mill 110, and initial settings for the coiling temperature control, performed in advance as necessary.

For instance, the plate width control involves variations in temperature of a rolling material 120, as disturbances inhibiting enhancement in precision of the plate thickness. In some cases, rolling materials 120 heated in slab reheating furnaces 101 may have low temperature parts, referred to as skid marks, left for structural reasons of the slab reheating furnaces 101. Such low temperature parts are made hard, with tendencies for the plate thickness to be thicker, and also for the plate width to vary.

Description is now made of a relationship between temperature and quality of rolling material 120. Assuming a rolling material 120 in a slab reheating furnace 101, if it is not heated enough, there are remarkable occurrences of skid marks that will cause deviations of plate thickness to appear at frequencies of skid marks in transfer direction of the rolling material 120. Further, in the course of milling the rolling material 120 with low temperatures, where it is due to implement milling the hard material, the rough mill 105 and the finish mill 110 will require the more power for milling, needing increased energy consumption at drives for driving the rough mill 105 and the finish mill 110. Instead, for improvement in product quality of rolling materials 120, if their temperatures at the exits of slab reheating furnaces 101 are set to be relatively high, there will be increases in use of energy, as well as in emission amount of carbon dioxide, at the slab reheating furnaces 101.

To this point, according to the first embodiment, the optimization device 1 is connected to the control device 200 controlling the hot rolling mill 100, and is adapted for services to optimize the control of the hot rolling mill 100 by the control device 200, to minimize either or both of use of energy and emission amount of carbon dioxide at the hot rolling mill 100, while securing product qualities of rolling materials 120 milled by the hot rolling mill 100.

As shown in FIG. 1, the optimization device 1 includes a CPU 11, a ROM 12, a RAM 13, an input interface 14, a display 15, and a hard disc 16, while they are interconnected through a bus 20.

The ROM 12 is configured with nonvolatile semiconductors or the like, and has stored therein an operation system and an optimization program to be executed at the CPU 11.

The RAM 13 is configured with volatile semiconductors or the like, to temporarily store therein necessary data for use at the CPU 11 to execute various processes.

The hard disc 16 is configured to store therein necessary information for use at the CPU 11 to execute the optimization program. For instance, there is a set of optimization data each stored as combination of a control setting value, a use of energy, and an emission amount of manufacturing carbon dioxide, associated with each other.

The CPU 11 is adapted to centrally serve for controlling the optimization device 1.

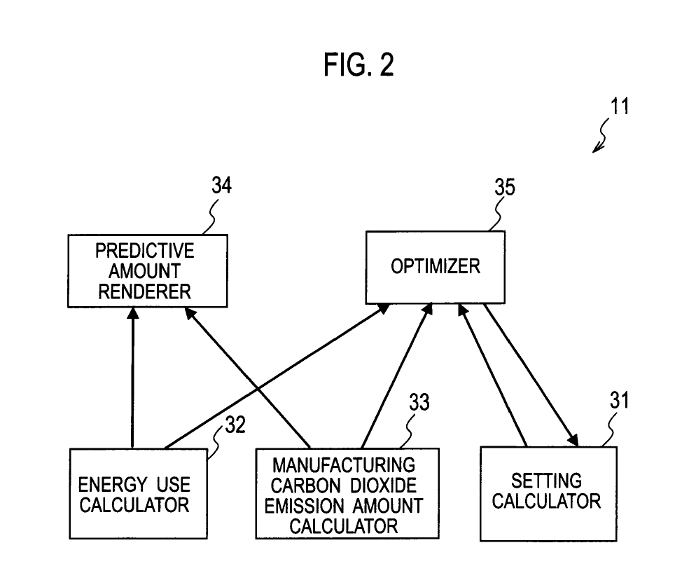

FIG. 2 is a configuration diagram showing configuration of the CPU 11 provided in the optimization device 1 according to the first embodiment.

As shown in FIG. 2, the CPU 11 is adapted for execution of the optimization program to functionally include a setting calculator 31, an energy use calculator 32, a manufacturing carbon dioxide emission amount calculator 33, a predictive amount renderer 34, and an optimizer 35.

The setting calculator 31 is adapted to operate to depend on combination of an initial size, an initial temperature, and a target temperature of a rolling material 120, to calculate a control setting value for services of the hot rolling mill 100 to mill the rolling material 120. Here, the initial size and the initial temperature refer to a size and a temperature at an entry of a slab reheating furnace 101, respectively, as they are input by user operations through the input interface 14, or supplied from another networked computer.

The energy use calculator 32 is adapted to operate to depend on a control setting value calculated by the setting calculator 31, to calculate a use of energy as a requisite energy for services of the hot rolling mill 100 to mill the rolling material 120.

The manufacturing carbon dioxide emission amount calculator 33 is adapted to operate to depend on a coefficient of carbon dioxide emission and a use of energy calculated by the energy use calculator 32, to calculate an emission amount of manufacturing carbon dioxide emitted or to be emitted at the hot rolling mill 100.

The predictive amount renderer 34 is adapted to render on the display 15 a use of energy calculated by the energy use calculator 32, and an emission amount of manufacturing carbon dioxide calculated by the manufacturing carbon dioxide emission amount calculator 33.

The optimizer 35 is adapted to calculate the target temperature to be a temperature equal to or higher than a requisite temperature for the rolling material 120 to be milled with secured qualities, as a temperature to minimize either or both of use of energy and emission amount of manufacturing carbon dioxide.

### <Operation>

Description is now made of operation of the optimization device 1 according to the first embodiment.

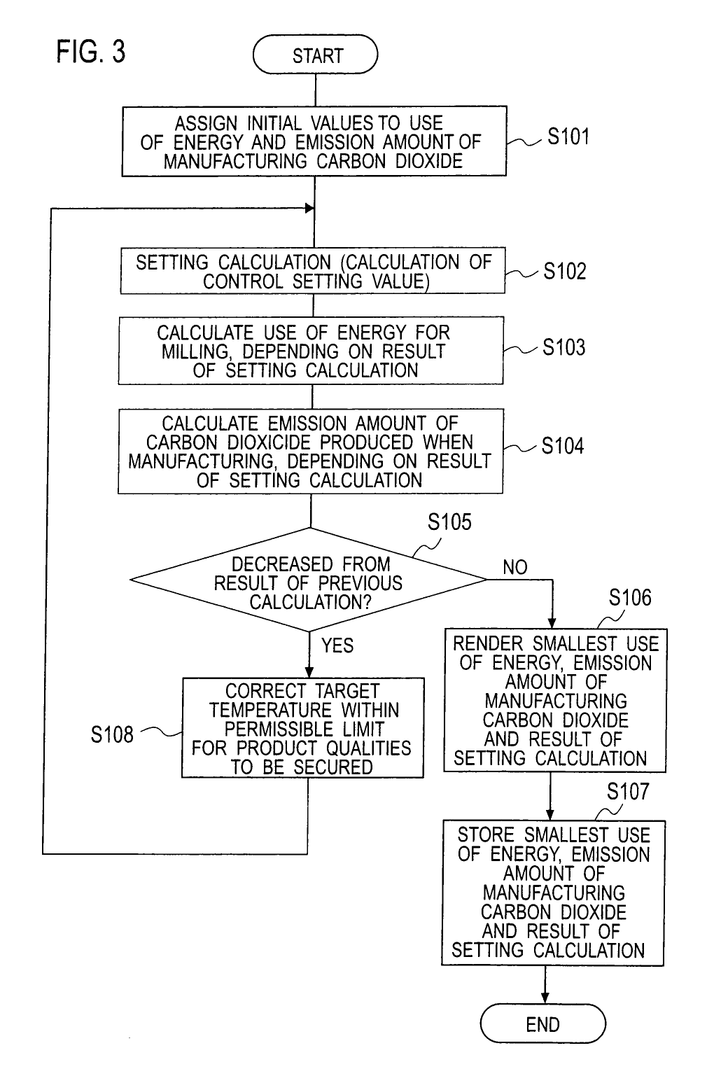

FIG. 3 is a flowchart of processes to be implemented at the optimization device 1 according to the first embodiment.

As shown in FIG. 3, in the optimization device 1, the CPU 11 operates (at a step S101) to assign initial values to the use of energy and the emission amount of manufacturing carbon dioxide. Here, the initial values assigned should be sufficient large values.

Next, at the CPU 11 in the optimization device 1, (at a step S102) the setting calculator 31 operates to calculate a requisite control setting value for a stable high-precision milling of a rolling material 120.

More specifically, first, the setting calculator 31 operates to depend on combination of an initial size and an initial weight of the rolling material 120 in normal temperature, to assume a duty for the rolling material 120 to be charged into a slab reheating furnace 101 to heat up to a target temperature, to calculate how long, at what degrees of atmosphere temperature, the residence in the furnace should be kept to do well. Further, the setting calculator 31 operates to depend on combination of dimensions and temperatures of the rolling material 120 at an exit of the slab reheating furnace 101, for use of a rolling model to calculate rolling loads, deformation resistances, rolling torques, and rolling powers. Further, the setting calculator 31 operates to calculate a rolling speed setting value, and a roll gap setting value.

Next, at the CPU 11, (at a step S103) the energy use calculator 32 operates to depend on a control setting value calculated at the setting calculator 31, to calculate a use of energy as a requisite energy for services of the hot rolling mill 100 to mill the rolling material 120. More specifically, the energy use calculator 32 operates to calculate, as items of the use of energy, a direct energy that is a requisite energy simply for duties to mill the rolling material 120, and an indirect energy as an energy that is not directly poured into the rolling material 120, but indispensable in the production, respectively. It is noted that the use of energy is calculated by a later-described method.

Next, at the CPU 11, (at a step S104) the manufacturing carbon dioxide emission amount calculator 33 operates to depend on combination of a carbon dioxide emission coefficient and a use of energy calculated at the energy use calculator 32, to calculate an emission amount of manufacturing carbon dioxide at the hot rolling mill 100.

Here, the carbon dioxide emission coefficient refers to a coefficient for use to calculate how much carbon dioxide is to be emitted when a fuel or electric power is consumed. For instance, for natural gas, it is prescribed to be 0.5526 (kg-C/kg) (as 0.5526 kg of carbon to be emitted when 1 kg of natural gas is combusted), or 2.025 (kg-CO2/kg) (as 2.025 kg of carbon dioxide to be emitted when 1 kg of natural gas is combusted). For consumption of 1 (kWh) of electricity, it is prescribed to be 0.555 (kg-CO2/kg) of carbon dioxide.

In this regard, the manufacturing carbon dioxide emission amount calculator 33 is adapted to depend on a carbon dioxide emission coefficient stored in memory in advance, to calculate an emission amount of carbon dioxide commensurate with a direct energy calculated by the energy use calculator 32, and an emission amount of carbon dioxide commensurate with an associated indirect energy, respectively. Here, the emission amount of manufacturing carbon dioxide refers to a sum of the emission amount of carbon dioxide commensurate with the direct energy and the emission amount of carbon dioxide commensurate with the indirect energy.

Next, (at a step S105) the optimizer 35 operates between combination of the use of energy calculated at the step S103 and the emission amount of manufacturing carbon dioxide calculated at the step S104 and combination of a use of energy and an emission amount of manufacturing carbon dioxide calculated in a previous time, to determine whether or not the former is decreased from the latter.

At the step S105, unless the former is determined as decreased from the combination of the use of energy and the emission amount of manufacturing carbon dioxide calculated in the previous time (in the case of NO), then (at a step S106) the predictive amount renderer 34 operates to render on the display 15 the combination of the use of energy and the emission amount of manufacturing carbon dioxide as calculated. More specifically, the predictive amount renderer 34 is adapted to render a use of energy (as a direct energy+an indirect energy) calculated at the energy use calculator 32, and combination of an emission amount of carbon dioxide commensurate with the direct energy and an emission amount of carbon dioxide commensurate with the indirect energy the manufacturing carbon dioxide emission amount calculator 33 has calculated, respectively. Rendering them enables presentation of use of energy and emission amount of manufacturing carbon dioxide, as operational reference information to, among other, operators and service men.

Further, (at a step S107) the optimizer 35 operates to have the control setting value, use of energy, and emission amount of manufacturing carbon dioxide associated with each other, to store as an optimization data in the hard disc 16.

On the other hand, at the step S105, if the former is determined as decreased from the combination of the use of energy and the emission amount of manufacturing carbon dioxide calculated in the previous time (in the case of YES), then (at a step S108) the optimizer 35 operates to have a target temperature of the rolling material 120 set low within a range of equal to or higher than a threshold temperature required to secure qualities of the rolling material 120 as rolled, before the process flow again goes to the step S102. Here, for the threshold temperature, there should be a set of adequate values calculated in advance on bases of actual measures made in advance by the user, followed by an adequate value set in advance by the user, for instance, as an entry temperature of the finish mil 110 set to 980° C., or as an exit temperature of the finish mil 110 set to 840° C.

Such being the case, there is a sequence of steps S102 to S108 of processes executed to repeat until the use of energy and the emission amount of manufacturing carbon dioxide calculated at the steps S103 to S104 become equal to or larger than a use of energy and an emission amount of manufacturing carbon dioxide calculated at steps S103 to S104 in the previous loop of processes, respectively. The optimizer 35 is thereby adapted to calculate a target temperature of a rolling material 120 as a requisite temperature to secure qualities of the rolling material 120 as rolled, and simultaneously as a temperature selective to minimize the use of energy and the emission amount of manufacturing carbon dioxide.

It is noted that, at the optimizer 35, there is made a decision as to whether or not the use of energy calculated at the step S103 and the emission amount of manufacturing carbon dioxide calculated at the step S104 are decreased from a use of energy and an emission amount of manufacturing carbon dioxide calculated in the previous time, while this is not restrictive, so there may be a decision made of whether or not at least one of the use of energy calculated at the step S103 and the emission amount of manufacturing carbon dioxide calculated at the step S104 is decreased from a use of energy or an emission amount of manufacturing carbon dioxide calculated in the previous time.

### <Energy use Calculations>

Description is now made of energy use calculation processes implemented at the energy use calculator 32.

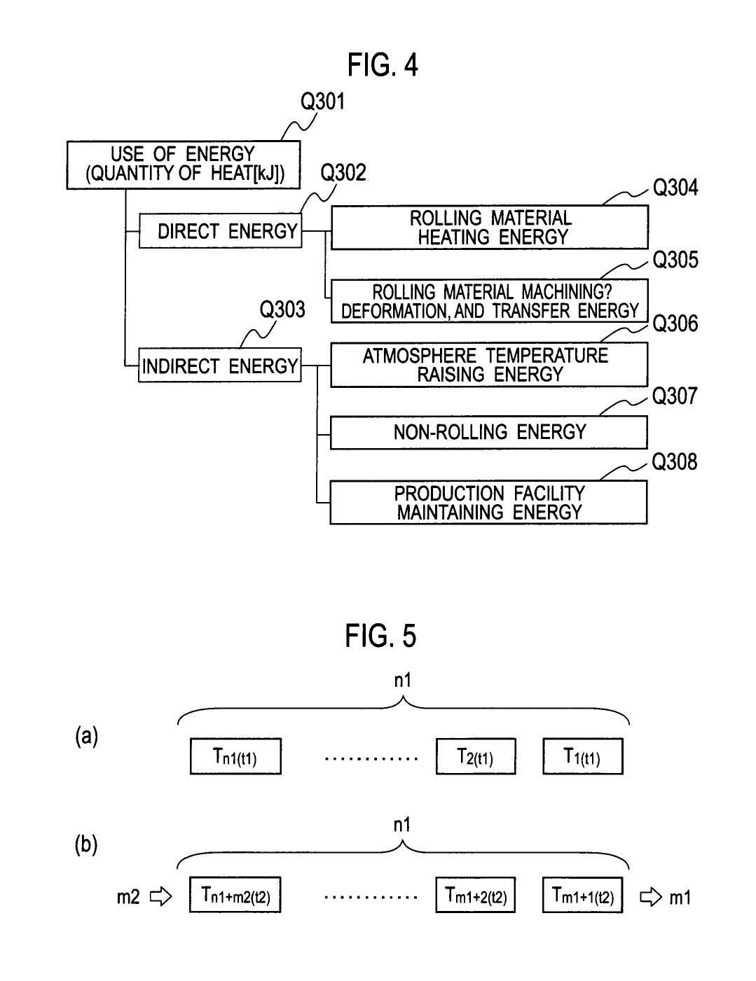

FIG. 4 is a diagram showing a categorization of energy use items calculated at the energy use calculator 32.

As shown in FIG. 4, there is a use of energy Q301 calculated at the energy use calculator 32, which is categorized into a direct energy Q302 as an item of energy required simply for duties to mill a set of rolling materials 120, and an indirect energy Q303 as an item of energy not directly poured into those rolling materials 120, but indispensable in the production.

Further, the direct energy Q302 is calculated as a sum of a rolling material heating energy Q304 and a rolling material machining, deforming, and transferring energy Q305, the indirect energy Q303 being calculated as a sum of an atmosphere temperature raising energy Q306, a non-rolling energy Q307, and a production facility maintaining energy Q308.

The rolling material heating energy Q304 is an item of energy powered into the rolling materials 120 by combustion of fuel in the slab reheating furnaces 101.

The rolling material machining, deforming, and transferring energy Q305 is a sum of items of required energy in courses of deforming the rolling materials 120 at mill stands in the rough mill 105 and those in the finish mill 110, and energy for transferring the rolling materials 120 along the transfer line.

The atmosphere temperature raising energy Q306 is an item of energy required to have raised atmosphere temperatures in the slab reheating furnaces 101. When heating rolling materials 120, the slab reheating furnaces 101 should have atmosphere therein raised in temperature, as well, with extra energy input as necessary to supplement fractions of heat dissipated at walls of the slab reheating furnaces 101.

The non-rolling energy Q307 is an item of energy for a set of tasks including those of retaining revolutions of rolls at mill stands as well as retaining revolutions of rollers on transfer tables, without rolling materials 120 being thereby rolled or transferred. Also, there is involved energy consumed at electric motors for pumps to be always kept rotated to hold constant pressures, such as those of oil and water.

The production facility maintaining energy Q308 is an item of energy required at production facilities, without constituting any item of direct energy for producing rolling materials 120.

Description is now made of methods of calculating a rolling material heating energy Q304, a rolling material machining, deforming, and transferring energy Q305, an atmosphere temperature raising energy Q306, a non-rolling energy Q307, and a production facility maintaining energy Q308 at the energy use calculator 32.

(Calculating a Rolling Material Heating Energy Q304)

The energy use calculator 32 is operable to depend on a weight W (kg), an initial temperature T1 (° C.), a target temperature T2 (° C.), and a specific heat (kJ/kg/K) of a rolling material 120, to calculate a rolling material heating energy Q304 (kJ) using a mathematical expression 1 given below. For instance, for a duty item on a rolling material 120 with a weight of 15 (tons) to raise the temperature from 30 (° C.) to 1,230 (° C.), assuming a specific heat of iron steel to be 0.5 (kJ/kg/K), the energy use calculator 32 employs the mathematical expression 1 below, to calculate a rolling material heating energy Q304, such that it is 9,000,000 (kJ) (=0.5×1,200×15,000).

Q304=C*(T2−T1)*W (mathematical expression 1).

(Calculating an Atmosphere Temperature Raising Energy Q306)

The energy use calculator 32 is operable to calculate an atmosphere temperature raising energy Q306 depending on an amount of fuel input to a slab reheating furnace 101.

FIG. 5 is a combination of illustrations describing a method of calculating an atmosphere temperature raising energy Q306 at the energy use calculator 32; (a) is an illustration of rolling materials 120 residing in a slab reheating furnace 101 at a time t1, and (b), an illustration of rolling materials 120 residing in the slab reheating furnace 101 at a time t2 after the time t1.

As illustrated in FIG. 5(a), at a time t1, the slab reheating furnace 101 has n1 rolling materials 120 residing therein, with their initial temperatures T1(t1), T2(t1), . . . , Tn1(t1) in order from a nearest one relative to an exit of the slab reheating furnace 101.

As illustrated in FIG. 5(b), at a time t2 after the time t1, the slab reheating furnace 101 has had till then m1 (m1<n1) rolling materials 120 discharged therefrom, and m2 rolling materials 120 charged therein anew. At this time t2, assuming the rolling materials 120 as having their temperatures Tm1+1(t2), Tm1+2(t2), . . . , Tn1+m2(t2) in order from the nearer end to the exit of the slab reheating furnace 101, the energy use calculator 32 operates to calculate a thermal energy Q1 (kJ) directly received by rolling materials 120 between the times t1-t2, using a mathematical expression given below.

Q1=Q2+Q3+Q4 (mathematical expression 2),

where Q2 (kJ) is “an energy for courses of temperature rise of the first to the m1-th slab, from their initial temperatures to their temperatures at times of discharge”, Q3 (kJ), “an energy for courses of temperature rise of the m1+1-th to the n1-th slab, from their initial temperatures to their temperatures at the time t2”, and Q4 (kJ), “an energy for courses of temperature rise of the n1+1-th to the n2-th slab, from their temperatures (normal temperatures) at times of charge-in to their temperatures at the time t2”.

It is noted that the energy use calculator 32 is operable to employ the mathematical expression 1 above, to calculate respective one of Q2, Q3, and Q4, depending on associated specific heats, initial temperatures, final temperatures, and weights.

Further, the energy use calculator 32 operates for calculations based on a whole quantity of fuel input to the slab reheating furnace 101 during the interval of time from t1 to t2, to determine an energy Q5 (kJ) the fuel has.

Then, the energy use calculator 32 operates to calculate an atmosphere temperature raising energy Q306 (kJ) using a mathematical expression 3 given below

Q306=Q5−Q1 (mathematical expression 3).

(Calculating a Rolling Material Machining, Deforming, and Transferring Energy 305)

The energy use calculator 32 is adapted for operations to calculate a rolling material machining, deforming, and transferring energy 305, as a sum of required energy Q6 in courses including machining and deforming rolling materials 120 at the rough mill 105 and the finish mill 110, and required energy Q7 for transferring the rolling materials 120.

The energy use calculator 32 operates on rolling torques calculated by the setting calculator 31 using a rolling model, for adding thereto loss torques and acceleration torques to calculate resultant torques. It is noted that the setting calculator 31 is adapted for operations to calculate deformation resistances depending on properties and temperatures of rolling materials 120, calculate rolling loads depending on deformation resistances thus calculated, and calculate rolling torques required for deformations of the rolling materials 120 depending on rolling loads thus calculated.

Moreover, the energy use calculator 32 operates for each of torques calculated to be output at electric motors of the rough mill 105 and the finish mill 110, to calculate necessary power P (W) therefor using a mathematical expression 4 given below, where N is torque (N·m), and ω is an angular speed (rad/s).

P(W)=N(N·m)×ω(rad/s) (mathematical expression 4).

Further, the energy use calculator 32 operates on combination of a determined rolling speed vp (km/H) and a length of a rolling material 120 in the transfer direction, to calculate therefrom a rolling time Tp (H), for use of a mathematical expression 5 given below to calculate an energy Q6 (kJ) required in courses including machining and deforming the rolling material 120 at the rough mill 105 and the finish mill 110.

Q6(kJ)=P(kW)×Tp(H) (mathematical expression 5).

It is noted that the rough mill 105 as well as the finish mill 110 may have a sizing press for correcting the plate width, besides the mill stands. Further, the coilers 114, though being different from mill stands, have their power consumption models of general formats, so the models are employed to perform calculations like the above.

Next, for the rolling material 120 being transferred with its weight shared among associated electric motors, the energy use calculator 32 operates to calculate torque N (N·m) per one electric motor from a shared weight of the rolling material 120. Then, the energy use calculator 32 operates on combination of a determined transfer speed vt (km/H) and the length of the rolling material 120 in the transfer direction, to calculate therefrom a transfer time Tt (H), for use of a mathematical expression 6 given below to calculate an energy Q7 (kJ) required for transfer of the rolling material 120.

Q7(kJ)=P(kW)×Tt(H) (mathematical expression 6).

It is noted that the energy Q7 involves also an energy required for transfer of the rolling material 120 in a slab reheating furnace 101, as it is added.

Then, the energy use calculator 32 operates to calculate a rolling material machining, deforming, and transferring energy Q305, as a sum of the energy Q6 required in courses including machining and deforming the rolling material 120 at the rough mill 105 and the finish mill 110, and the energy Q7 required for transfer of the rolling material 120.

(Calculating a Non-Rolling Energy Q307)

The energy use calculator 32 is adapted to make this calculation by determining an energy Q8 (kJ) input to an entirety of the hot rolling mill 100 within an interval of time, minus a rolling material machining, deforming, and transferring energy Q305 consumed within the interval. It is noted that the energy Q8 input to the entirety of hot rolling mill 100 is calculated on bases of measures at electric energy meters in an energy transmission and distribution system for supplying electric power to the hot rolling mill 100.

(Calculating a Production Facility Maintaining Energy Q308)

The energy use calculator 32 is adapted for operations to calculate a production facility maintaining energy Q308 as combination of energies consumed at the control device 200, and energies consumed by heating, ventilation, and air-conditioning equipment and lighting appliances at residence rooms used by operational personnel for and service men of the hot rolling mill 100, as they are determined on bases of measures at electric energy meters in a power supply system.

Such being the case, the energy use calculator 32 is adapted for operations to depend on a control setting value calculated at the setting calculator 31, to calculate a rolling material heating energy Q304, a rolling material machining, deforming, and transferring energy Q305, an atmosphere temperature raising energy Q306, a non-rolling energy Q307, and a production facility maintaining energy Q308, respectively, and to calculate a use of energy, as a sum between a direct energy Q302 being a necessary energy for duties of the hot rolling mill 100 to mill a set of rolling materials 120, that is, a sum of the rolling material heating energy Q304 and the rolling material machining, deforming, and transferring energy Q305, and an indirect energy Q303 being a sum of the atmosphere temperature raising energy Q306, the non-rolling energy Q307, and the production facility maintaining energy Q308.

As will be seen from the foregoing, according to the first embodiment, there is an optimization device 1 including a setting calculator 31 configured to depend on an initial size, an initial temperature, and a target temperature of a rolling material, to calculate a control setting value for services of a hot rolling mill 100 to mill the rolling material 120, an energy use calculator 32 configured to depend on the control setting value calculated at the setting calculator 31, to calculate a use of energy as a necessary energy for services of the hot rolling mill 100 to mill the rolling material 120, a manufacturing carbon dioxide emission amount calculator 33 configured to depend on a carbon dioxide emission coefficient and the use of energy calculated at the energy use calculator 32, to calculate an emission amount of carbon dioxide emitted at the hot rolling mill 100, and an optimizer 35 configured to calculate the target temperature to be a temperature equal to or higher than a requisite temperature for the rolling material 120 to be milled with a secured quality, as a temperature to minimize either or both of use of energy and emission amount of carbon dioxide, thus permitting control of the hot rolling mill 100 to be optimized, so as to minimize either or both of use of energy and emission amount of manufacturing carbon dioxide, allowing for a secured product quality of the rolling material 120.

It is noted that the first embodiment described is addressed to an example applied to a hot rolling system 300 including a hot rolling mill 100, while it is applicable not simply thereto, but also to a rolling system including a hot sheet rolling mill, a plate rolling mill, a cold rolling mill, a section steel or iron rolling mill, a steel bar or wire rod rolling mill, or an aluminum or copper rolling facility.

### Second Embodiment

Description is now made of an optimization device 1A according to a second embodiment.

According to the second embodiment, the optimization device 1A is connected to a control device 200 controlling a hot rolling mill 100, like the optimization device 1 according to the first embodiment shown in FIG. 1.

Further, according to the second embodiment, the optimization device 1A includes a CPU 11A, a ROM 12, a RAM 13, an input interface 14, a display 15, and a hard disc 16. Among them, the ROM 12, the RAM 13, the display 15, and the hard disc 16 are identical in configuration to those designated by identical reference signs at the optimization device 1 according to the first embodiment, so redundant description is omitted.

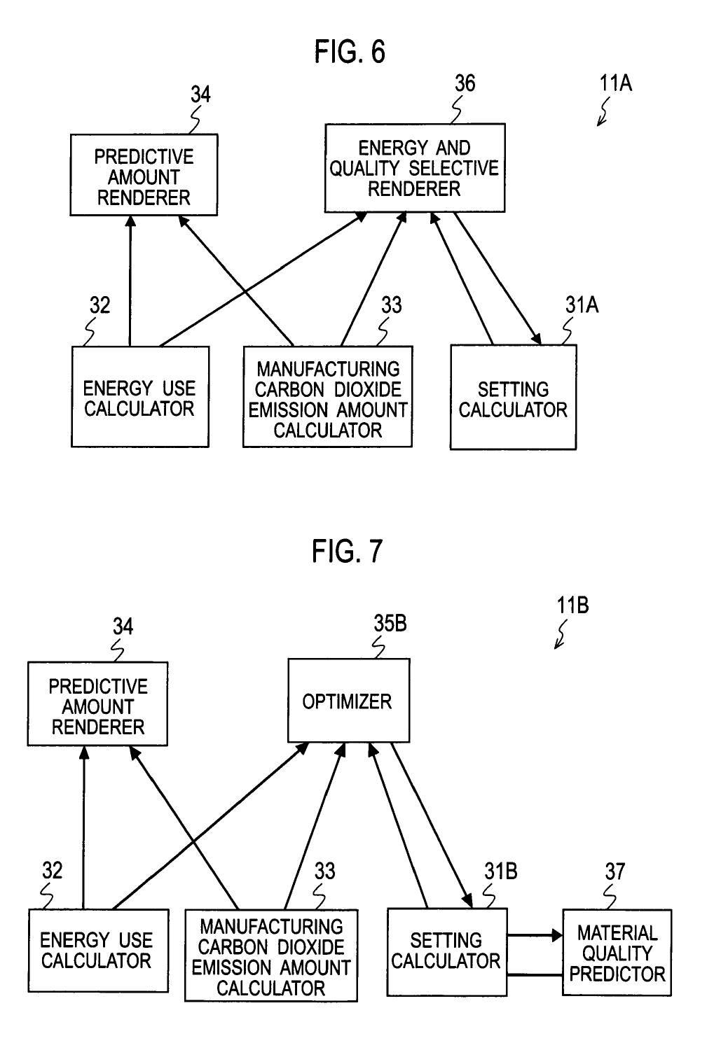

FIG. 6 is a configuration diagram showing configuration of the CPU 11A provided in the optimization device 1A according to the second embodiment.

As shown in FIG. 6, the CPU 11 is adapted to functionally include a setting calculator 31A, an energy use calculator 32, a manufacturing carbon dioxide emission amount calculator 33, a predictive amount renderer 34, and an energy and quality selective renderer 36. Among them, the energy use calculator 32, the manufacturing carbon dioxide emission amount calculator 33, and the predictive amount renderer 34 are identical in configuration to those designated by identical reference signs at the optimization device 1 according to the first embodiment, so redundant description is omitted.

The setting calculator 31A is adapted to operate to depend on combination of an initial size, an initial temperature, and a set of target temperatures of a rolling material 120, to have a set of control setting values calculated every target temperature for services of the hot rolling mill 100 to mill the rolling material 120.

As an example of the set of target temperatures, here is assumed a set of target values preset to be 840, 860, 880, 900, and 920 (° C.) as temperatures at an exit of a finish mill 110.

The energy and quality selective renderer 36 is adapted to render on the display 15 a set of uses of energy calculated at the energy use calculator 32 and emission amounts of manufacturing carbon dioxide calculated at the manufacturing carbon dioxide emission amount calculator 33. Then, given a user's operation as an operation signal through the input interface 14 for selecting any one of the rendered set of combinations of use of energy and emission amount of manufacturing carbon dioxide, the energy and quality selective renderer 36 operates to depend on the operation signal thus supplied, to select, from a set of target temperatures, a single target temperature corresponding to a selected combination of use of energy and emission amount of manufacturing carbon dioxide.

This affords the user to give an operation for selecting a combination of use of energy and emission amount of manufacturing carbon dioxide, to set up a target temperature, thus permitting the hot rolling mill 100 to be controlled for optimization to minimize either or both of use of energy and emission amount of manufacturing carbon dioxide, allowing for a secured product quality of the rolling material 120.

### Third Embodiment

Description is now made of an optimization device 1B according to a third embodiment.

According to the third embodiment, the optimization device 1B is connected to a control device 200 controlling a hot rolling mill 100, like the optimization device 1 according to the first embodiment shown in FIG. 1.

Further, according to the third embodiment, the optimization device 1B includes a CPU 11B, a ROM 12, a RAM 13, an input interface 14, a display 15, and a hard disc 16. Among them, the ROM 12, the RAM 13, the input interface 14, the display 15, and the hard disc 16 are identical in configuration to those designated by identical reference signs at the optimization device 1 according to the first embodiment, so redundant description is omitted.

FIG. 7 is a configuration diagram showing configuration of the CPU 11B provided in the optimization device 1B according to the third embodiment.

As shown in FIG. 7, the CPU 11B is adapted to functionally include a setting calculator 31B, an energy use calculator 32, a manufacturing carbon dioxide emission amount calculator 33, a predictive amount renderer 34, an optimizer 35B, and a material quality predictor 37. Among them, the energy use calculator 32, the manufacturing carbon dioxide emission amount calculator 33, and the predictive amount renderer 34 are identical in configuration to those designated by identical reference signs at the optimization device 1 according to the first embodiment, so redundant description is omitted.

The setting calculator 31B is adapted to operate for use of a temperature model for heat balance calculation of a rolling material 120 residing in the hot rolling mill 100, to calculate a control setting value, and depend thereon, to calculate temperatures of the rolling material 120 in the hot rolling mill 100.

The material quality predictor 37 is adapted to operate to depend on temperatures calculated at the setting calculator 31B, to determine material qualities of the rolling material 120. Here, the material qualities refer to one or more qualities out of tensile strength, yield stress, and ductility.

The optimizer 35B is adapted to calculate a target temperature, as a temperature minimizing either or both of use of energy and emission amount of manufacturing carbon dioxide, allowing for an ensured material quality determined at the material quality predictor 37, as a material quality better than preset.

### <Operation>

Description is now made of operation of the optimization device 1B according to the third embodiment.

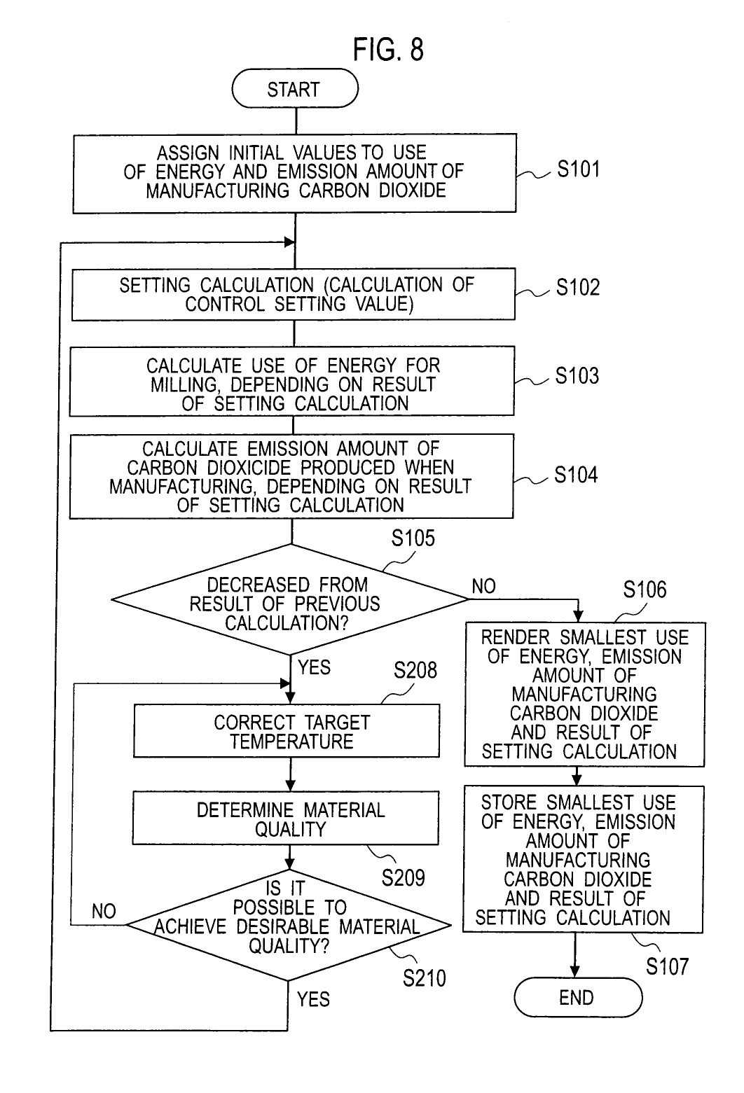

FIG. 8 is a flowchart of process flow to be implemented at the optimization device 1B according to the third embodiment. It is noted that the flowchart shown in FIG. 8 has processes implemented at steps S101 to S107, which are identical to those implemented at the steps S101 to S107 in the flowchart for the optimization device 1 according to the third embodiment shown in FIG. 3, and redundant description is omitted.

At a step S105, if it is determined that there are decreases relative to combination of a use of energy and an emission amount of manufacturing carbon dioxide calculated in a previous time (in the case of YES), then (at a step S208) the material quality predictor 37 operates to correct a target temperature of a rolling material 120. More specifically, in a process flow having come in from the step S105, the target temperature as currently set is updated to a lower target temperature, but in a process flow having come in from a later-described step S210, the target temperature as currently set is updated to a higher target temperature.

Then, (at a step S209) the material quality predictor 37 operates to depend on the target temperature as updated, to determine a material quality of the rolling material 120. For instance, the material quality predictor 37 may operate for use of techniques described in JP 2007-832999 A or techniques described in literature: Nishiyama Memorial Course “Prediction and Control of Material Quality in Continuous Hot Rolling Mill Process” by the Iron and Steel Institute of Japan (Incorporated), Nos. 131-132, to determine a tensile strength, a yield stress, and a ductility of a rolling material 120 manufactured to a target temperature thus set up.

Next, (at the step S210) the optimization device 35B operates to determine whether or not the material quality calculated at the step S209 is equal to or higher than a preset threshold of material quality.

At the step S210, if it is determined that the material quality calculated at the step S209 is equal to or higher than the preset threshold of material quality, then the process flow at the optimization device 35B goes to a step S102, but if it is determined that the material quality calculated at the step S209 is lower than the preset threshold of material quality, then the process flow goes to the step S208.

Such being the case, there is a sequence of processes executed at the steps S208 to S210 to repeat until the material quality calculated at the step S209 gets equal to or higher than the preset threshold of material quality, in association with a sequence of processes executed at steps S102 to S210 to repeat until combination of a use of energy and an emission amount of manufacturing carbon dioxide calculated at steps S103 to S104 gets equal to or higher than combination of a use of energy and an emission amount of manufacturing carbon dioxide calculated at steps S103 to S104 in a previous loop of processes.

The optimizer 35B is thereby adapted to calculate a target temperature of a rolling material 120, as a temperature minimizing use of energy and emission amount of carbon dioxide, allowing for an ensured material quality determined at the material quality predictor 37, as a material quality better than preset.

### Fourth Embodiment

Description is now made of an optimization device 1C according to a fourth embodiment.

According to the fourth embodiment, the optimization device 1C is connected to a control device 200 controlling a hot rolling mill 100, like the optimization device 1A according to the second embodiment.

Further, according to the fourth embodiment, the optimization device 1C includes a CPU 11C, a ROM 12, a RAM 13, an input interface 14, a display 15, and a hard disc 16. Among them, the ROM 12, the RAM 13, the input interface 14, the display 15, and the hard disc 16 are identical in configuration to those designated by identical reference signs at the optimization device 1A according to the second embodiment, so redundant description is omitted.

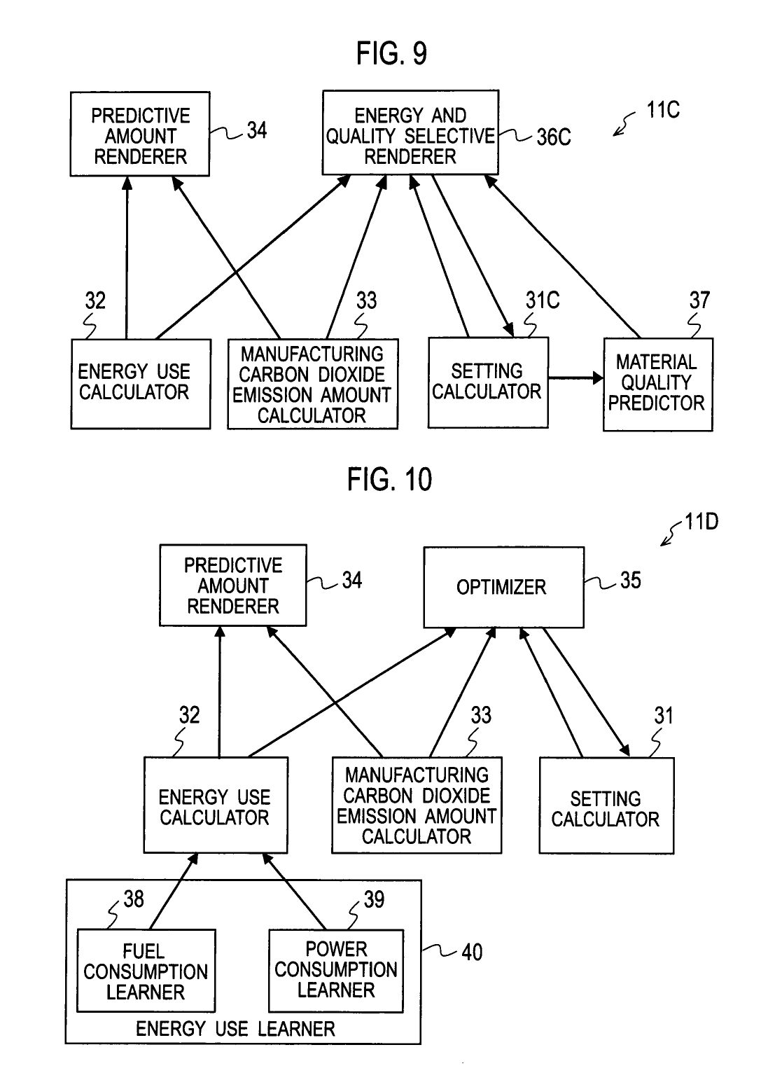

FIG. 9 is a configuration diagram showing configuration of the CPU 11C provided in the optimization device according to the fourth embodiment.

As shown in FIG. 9, the CPU 11C is adapted to functionally include a setting calculator 31C, an energy use calculator 32, a manufacturing carbon dioxide emission amount calculator 33, a predictive amount renderer 34, an energy and quality selective renderer 36C, and a material quality predictor 37. Among them, the energy use calculator 32, the manufacturing carbon dioxide emission amount calculator 33, and the predictive amount renderer 34 are identical in configuration to those designated by identical reference signs at the optimization device 1A according to the second embodiment, so redundant description is omitted.

The setting calculator 31C is adapted to operate for use of a temperature model for heat balance calculation of a rolling material 120 residing in the hot rolling mill 100, to calculate a control setting value, and depend thereon, to calculate temperatures of the rolling material 120 in the hot rolling mill 100.

The material quality predictor 37 is adapted to operate to depend on temperatures calculated at the setting calculator 31C, to determine material qualities of the rolling material 120. Here, the material qualities refer to one or more qualities out of tensile strength, yield stress, and ductility.

The energy and quality selective renderer 36C is adapted to render on the display 15 a set of uses of energy calculated at the energy use calculator 32, emission amounts of manufacturing carbon dioxide calculated at the manufacturing carbon dioxide emission amount calculator 33, and material qualities calculated at the material quality predictor 37. Then, given a user's operation as an operation signal through the input interface 14 for selecting any one of the rendered set of combinations of use of energy, emission amount of manufacturing carbon dioxide, and material quality, the energy and quality selective renderer 36C operates to depend on the operation signal thus supplied, to select, from a set of target temperatures, a single target temperature corresponding to a selected combination of use of energy, emission amount of manufacturing carbon dioxide, and material quality.

This affords the user to give an operation for selecting a combination of use of energy, emission amount of manufacturing carbon dioxide, and material quality, to set up a target temperature, thus permitting the hot rolling mill 100 to be controlled for optimization to minimize either or both of use of energy and emission amount of manufacturing carbon dioxide, allowing for a secured quality of the rolling material 120.

### Fifth Embodiment

Description is now made of an optimization device 1D according to a fifth embodiment.

According to the fifth embodiment, the optimization device 1D is connected to a control device 200 controlling a hot rolling mill 100, like the optimization device 1 according to the first embodiment.

Further, according to the fifth embodiment, the optimization device 1D includes a CPU 11D, a ROM 12, a RAM 13, an input interface 14, a display 15, and a hard disc 16. Among them, the ROM 12, the RAM 13, the input interface 14, the display 15, and the hard disc 16 are identical in configuration to those designated by identical reference signs at the optimization device 1 according to the first embodiment, so redundant description is omitted.

FIG. 10 is a configuration diagram showing configuration of the CPU 11D provided in the optimization device according to the fifth embodiment.

As shown in FIG. 10, the CPU 11D is adapted to functionally include a setting calculator 31, an energy use calculator 32, a manufacturing carbon dioxide emission amount calculator 33, a predictive amount renderer 34, an optimizer 35, a fuel consumption learner 38, and a power consumption learner 39. Among them, the setting calculator 31, the energy use calculator 32, the manufacturing carbon dioxide emission amount calculator 33, the predictive amount renderer 34, and the optimizer 35 are identical in configuration to those designated by identical reference signs at the optimization device 1 according to the first embodiment, so redundant description is omitted.

The fuel consumption learner 38 is adapted to depend on measures at fuel supply flow meters provided to the hot strip mill 100, to calculate energy used for services of the hot rolling mill 100 to mill a rolling material 120, as an actual use of energy, and depend on the actual use of energy as calculated, to correct a use of energy calculated at the energy use calculator 32.

The power consumption learner 39 is adapted to depend on measures at electric energy meters provided to the hot strip mill 100, to calculate energy used for services of the hot rolling mill 100 to mill a rolling material 120, as an actual use of energy, and depend on the actual use of energy as calculated, to correct a use of energy calculated at the energy use calculator 32.

It is noted that combination 40 of the fuel consumption learner 38 and the power consumption learner 39 is referred to as an energy use learner.

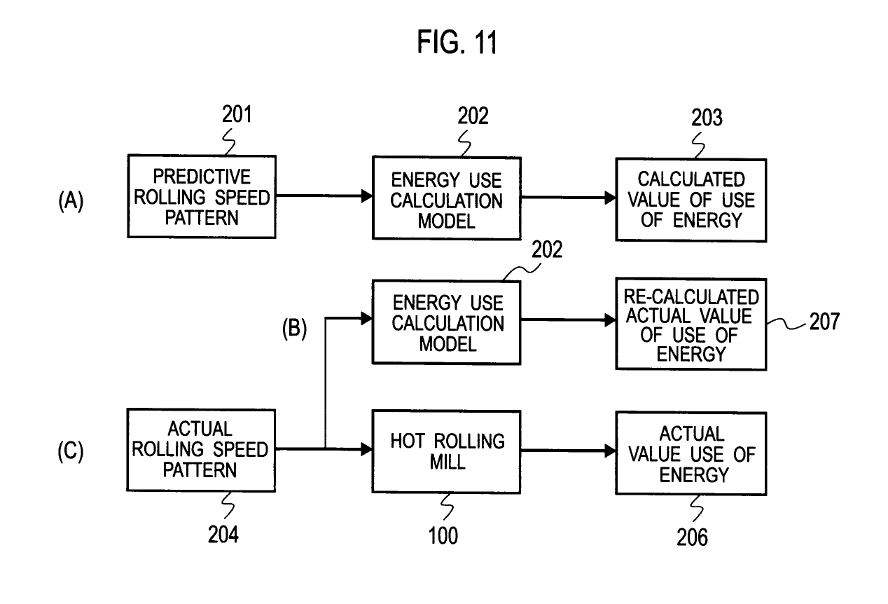

FIG. 11 is a diagram describing data calculation methods for study of energy use calculation models at the energy use learner 40.

As shown in FIG. 11, for calculations of use of energy, there is use of a calculation model that needs a rolling speed pattern as a variable to be input. The setting calculator 31 is due to execute a setting calculation before the hot rolling mill 100 enters a service for associated rolling, so (on a rout at (A)) the energy use calculator 32 is adapted to depend on a predictive rolling speed pattern 201 being a set of predicted rolling speeds, for calculation using an energy use calculation model 202 to determine a calculated value of a use of energy.

Further, the hot rolling mill 100 implements the rolling service with a transitioning rolling speed not always having planned values, sometimes giving rise to an actual rolling speed pattern 204 measured to be different in value from the predictive rolling speed pattern 201, so in some cases (on a route at (C)) there appears an actual value of use of energy 206 different from a calculated value of use of energy 203.

In such situations, for a study, if comparison is made between calculated values of use of energy and actual values of use of energy, then in the case of a combination of predictive rolling speed pattern and actual rolling speed pattern bearing a large difference in between, there would be learned a large value, whereby in some cases it might be called for a subsequent use, as a study value with large deviation, resulting in a debased precision.

To this point, as on a route at (B), the energy use learner 40 is adapted to record an actual rolling speed pattern 204 actually used, and depend on the actual rolling speed pattern 204 recorded, for calculation using an energy use calculation model 202 to determine a use of energy. Here, the use of energy 207 thus calculated at the energy use learner 40 is referred to as a re-calculated actual value of use of energy.

Then, for a study, the energy use learner 40 is adapted to make a comparison between a re-calculated value of use of energy 207 and an actual value of use of energy 206.

More specifically, at the energy use learner 40, the fuel consumption learner 38 operates for calculation using a mathematical expression 7 given below, to determine a fuel use study value Sf.

Sf=Q_{fcal}/Q_{fact} (mathematical expression 7),

where Q_{fcal} is a re-calculated actual value of use of energy by fuel, and Q_{fact} is an actual value of use of energy by fuel.

It is noted that the fuel consumption learner 38 is adapted to calculate the actual value of use of energy by fuel Q_{fact} depending on an amount of fuel supply to a slab reheating furnace 101 based on measures of fuel gauges.

Further, at the energy use learner 40, the power consumption learner 39 operates for calculation using a mathematical expression 8 given below, to determine an electricity use study value Se.

Se=Q_{ecal}/Q_{eact} (mathematical expression 8),

where Q_{ecal} is a re-calculated actual value of use of energy by electricity, and Q_{eact} is an actual value of use of energy by electricity.

It is noted that the power consumption learner 39 is adapted to calculate the actual value of use of energy by electricity Q_{eact} depending on an amount of supplied electric energy based on measures of electric energy meters.

Then, the energy use learner 40 operates to correct a use of energy calculated at the energy use calculator 32.

Use of energy is categorized as shown in FIG. 4, so the energy use learner 40 is adapted to operate, for instance, when given an electricity use study value Se of “1.1”, to correct a rolling material machining, deforming, and transferring energy calculated at the energy use calculator 32, by multiplying by “1.1”.

Such being the case, according to the fifth embodiment, there is an optimization device 1D including an energy use learner 40 adapted to depend on measures of electric energy meters or fuel gauges provided to a hot rolling mill 100, to calculate an amount of energy used for services of the hot rolling mill 100 to mill a rolling material 120, as an actual use of energy, and depend on the actual use of energy as calculated, to correct a use of energy calculated at an energy use calculator 32, thus allowing for an enhanced precision in calculation of the use of energy calculated at the energy use calculator 32.

### Sixth Embodiment

There have been first to fifth embodiments addressing reduction of a use of energy and an amount of carbon dioxide emitted in association with a manufacture of rolling material.

This sixth embodiment addresses reduction of a use of energy and an amount of carbon dioxide emitted in a life cycle of a rolling material 120 once shipped, and afterward, collected, and re-milled at a hot rolling mill 100.

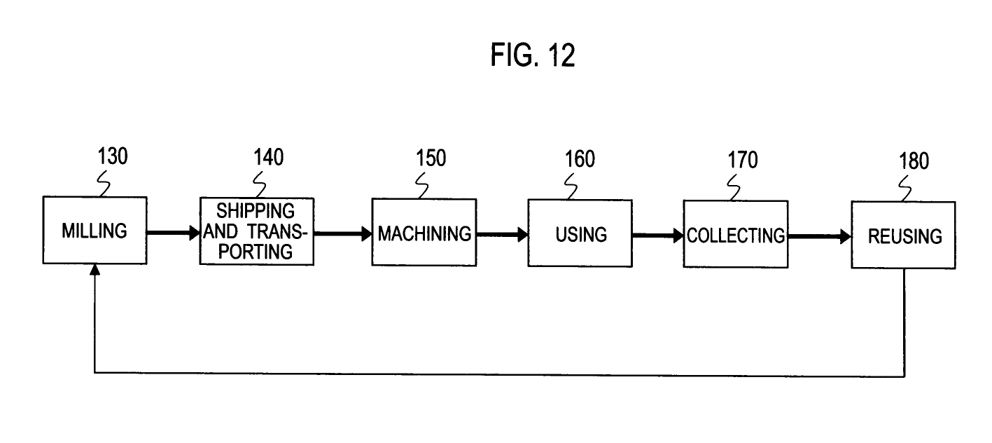

FIG. 12 is a diagram showing a life cycle of rolling materials 120 once shipped, and afterward, collected, and re-milled at a hot rolling mill 100.

As shown in FIG. 12, there is a set of rolling materials 120 each undergoing a sequence of stages including a milling 130, a shipping and transporting 140, a machining 150, a using 160, a collecting 170, and a re-using 180, to come home to the milling stage 130, for a recycle.

In such a lifecycle of rolling materials 120, at the using stage 160, for instance, there may be steel plates low in intensity, but applied to places requiring high intensities, with the need to thicken their thicknesses to compensate for deficiency of intensity. If they were then applied to automobiles, there would have been vehicles produced with increased body weights, resulting in debased fuel consumption. On the other hand, there may be steel plates high in intensity, and applied to automobiles. In this case, there can be similar intensities secured with thinner and light-weight steel plates, allowing for improved fuel consumption, with reduced environmental loads.

Further, for intensities to be increased there may be addition of minute traces of chemicals, such as niobium (Nb). In this case, added niobium may constitute, among others, a need for removal from recycled steel plates, or extra component inhibiting a re-use.

To this point, according to the sixth embodiment, there is an optimization device adapted for reduction of a use of energy and an amount of carbon dioxide emitted in a life cycle of a rolling material 120 once shipped, and afterward, collected, and re-milled at the hot rolling mill 100, as will be described by way of example.

According to the sixth embodiment, there is an optimization device 1E connected to a control device 200 controlling the hot rolling mill 100, like the optimization device 1 according to the first embodiment.

Further, according to the sixth embodiment, the optimization device 1E includes a CPU 11E, a ROM 12, a RAM 13, an input interface 14, a display 15, and a hard disc 16E. Among them, the ROM 12, the RAM 13, the input interface 14, and the display 15 are identical in configuration to those designated by identical reference signs at the optimization device 1 according to the first embodiment, so redundant description is omitted.

The hard disc 16E is configured to store therein necessary information for use at the CPU 11 to execute an optimization program. For instance, there is a set of optimization data each stored as combination of a control setting value, a use of energy, and an emission amount of manufacturing carbon dioxide, associated with each other. Further, the hard disc 16E includes a reference life cycle memory 16a.

The reference life cycle memory 16a is adapted to store therein, for each type of associated rolling materials 120, a reference life cycle as combination of a condition of use for a rolling material 120 to be used after shipment, and an amount of carbon dioxide to be emitted in a life cycle thereof including a shipment followed by a collection and a re-milling at the hot rolling mill 100, as they are associated with each other.

There may be a set of types of rolling materials 120 categorized inclusive of ultra-low carbon steel, low carbon steel, mild carbon steel, high carbon steel, stainless steel, alloy steel, and magnetic steel sheet, or following a steel type classification compliant with the JIS standard, such as SUS304, or the SC, or SAPH.

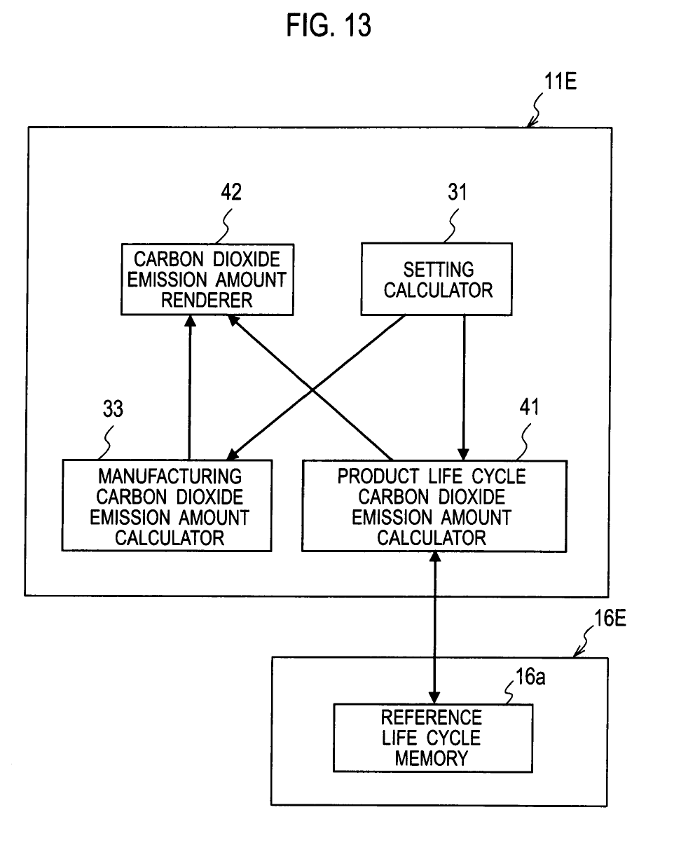

FIG. 13 is a configuration diagram showing configuration of the CPU 11E provided in the optimization device 1E according to the sixth embodiment.

As shown in FIG. 13, the CPU 11E is adapted to functionally include a setting calculator 31, a manufacturing carbon dioxide emission amount calculator 33, a product life cycle carbon dioxide emission amount calculator 41, and a carbon dioxide emission amount renderer 42. Among them, the setting calculator 31 and the manufacturing carbon dioxide emission amount calculator 33 are identical in configuration to those designated by identical reference signs at the optimization device 1 according to the first embodiment, so redundant description is omitted.

The product life cycle carbon dioxide emission amount calculator 41 is adapted to depend on a reference life cycle stored in the reference life cycle memory 16a, to calculate a product life cycle carbon dioxide emission amount that is an amount of carbon dioxide emitted in a life cycle of a rolling material 120 manufactured on the basis of a control setting value calculated at the setting calculator 31.

Description is now made of calculation of a product life cycle carbon dioxide emission amount of a type of rolling material 120 described below, for instance, (referred herein to as a steel material A), as it is stored in the reference life cycle memory 16a.

1) Steel type and size: SAPH 2 mm thick

2) Shipping destination: automobile manufacturer

3) Usage: passenger car frame, proportion of use in car body 10% (by weight)

4) Condition of use: car body weight 1,500 kg, yearly travel 20,000 km, fuel consumption in average 8 km/l gasoline

5) Duration of use: 15 years

6) Total emission amount of carbon dioxide: 7,500 kg as a total emission amount of carbon dioxide attributable to 150 kg of SAPH material

7) For passenger car, the emission amount of carbon dioxide is assumed to be approx. 0.25 kg for a 1 km travel, with a 10% contribution to the amount.

Here, the steel material A is assumed as having an intensity of 400 (MPa) in tensile strength, requiring steel materials used in the same passenger car to have a tensile strength of 400 (MPa).

The product life cycle carbon dioxide emission amount calculator 41 is adapted to calculate a total carbon dioxide emission amount assuming use of a steel material B that has a tensile strength of 500 (MPa), for instance.

In this situation, relative to the steel material A, the steel material B is stronger by 20 (%) in tensile strength, affording to thin the thickness by 20 (%). Hence, instead of the steel material A needing 150 (kg), substituting the steel material B allows for manufacturing a car body light-weighted (1,470 kg) by 30 (kg), that is, 20 (%) of 150 (kg).

To this point, the product life cycle carbon dioxide emission amount calculator 41 operates to calculate the total carbon dioxide emission amount as being 1,470/1,500×7,500 (kg)=7,350 (kg).

Then, the carbon dioxide emission amount renderer 42 operates to render, on the display 15, a product carbon dioxide emission amount and a product life cycle carbon dioxide emission amount.

Such being the case, there is rendered combination of a carbon dioxide emission amount in the entirety of a life cycle and a product carbon dioxide emission amount in course of manufacture on a mill line, thereby permitting the user to check up the carbon dioxide emission amount in the entire life cycle and the product carbon dioxide emission amount in course of manufacture on the mill line, while determining operational conditions of the hot rolling mill 100, thus allowing for the optimization device 1E to optimize control of the hot rolling mill 100.

### INDUSTRIAL APPLICABILITY

Embodiments herein are applicable to optimization devices for setting control devices for controlling hot rolling mills.

1. An optimization device comprising:
a setting calculator configured to depend on an initial size, an initial temperature, and a target temperature of a rolling material, to calculate a control setting value for services of a rolling mill to mill the rolling material;
an energy use calculator configured to depend on the control setting value calculated at the setting calculator, to calculate a use of energy as necessary energy for services of the rolling mill to mill the rolling material;
a manufacturing carbon dioxide emission amount calculator configured to depend on a carbon dioxide emission coefficient and the use of energy calculated at the energy use calculator, to calculate an emission amount of carbon dioxide emitted at the rolling mill; and
an optimizer configured to calculate the target temperature to be a temperature equal to or higher than a requisite temperature for the rolling material to be milled with a secured quality, as a temperature to minimize either or both of the use of energy and the emission amount of carbon dioxide.

2. The optimization device according to claim 1, wherein
the optimizer is configured to calculate a target temperature or target temperatures of the rolling material at one or more out of an entry and an exit of a finish mill adapted for services to finish mill the rolling material, and an entry of a coiler adapted for services to coil the rolling material as finish milled, in the rolling mill.

3. An optimization device comprising:
a setting calculator configured to depend on an initial size, an initial temperature, and a set of target temperatures of a rolling material, to have a set of control setting values calculated every target temperature for services of a rolling mill to mill the rolling material;
an energy use calculator configured to depend on the set of control setting values calculated at the setting calculator, to have a set of uses of energy calculated every control setting value as necessary energy for services of the rolling mill to mill the rolling material;
a manufacturing carbon dioxide emission amount calculator configured to depend on a carbon dioxide emission coefficient and the set of uses of energy calculated at the energy use calculator, to have a set of emission amounts of carbon dioxide emitted at the rolling mill calculated every use of energy; and
an energy and quality selective renderer configured to render on a display the set of uses of energy and the set of emission amounts of carbon dioxide as calculated, and depend on a selective one of combinations of use of energy and emission amount of carbon dioxide as rendered, to select one out of the set of target temperatures.

4. The optimization device according to claim 3, wherein
the energy and quality selective renderer is configured to select one out of the set of target temperatures at each of one or more out of an entry and an exit of a finish mill adapted for services to finish mill the rolling material, and an entry of a coiler adapted for services to coil the rolling material as finish milled, in the rolling mill.

5. The optimization device according to claim 1, comprising
the setting calculator being configured for use of a temperature model adapted for calculation of heat balance of the rolling material residing in the rolling mill, to depend on the control setting value as calculated, to calculate a temperature of the rolling material residing in the rolling mill,
further comprising a material quality predictor configured to depend on the temperature calculated at the setting calculator, to determine a material quality of the rolling material,
the optimizer being configured to calculate the target temperature as a temperature minimizing either or both of the use of energy and the emission amount of carbon dioxide, having the material quality determined at the material quality predictor as a material quality better than preset.

6. The optimization device according to claim 5, wherein
the material quality predictor is configured to calculate the material quality as a set of one or more out of tensile strength, yield stress, and ductility of the rolling material as rolled at the temperature of the rolling material calculated at the setting calculator.

7. The optimization device according to claim 3, comprising
the setting calculator being configured for use of a temperature model adapted for calculation of heat balance of the rolling material residing in the rolling mill, to depend on the set of control setting values as calculated, to calculate a set of temperatures of the rolling material residing in the rolling mill,
further comprising a material quality predictor configured to depend on the set of temperatures calculated at the setting calculator, to determine a set of material qualities of the rolling material,
the energy and quality selective renderer being configured to render on the display the set of uses of energy and the set of emission amounts of carbon dioxide as calculated, and the set of material qualities as determined, and depend on a selective one of combinations of use of energy, emission amount of carbon dioxide, and material quality as rendered, to select one out of the set of target temperatures.

8. The optimization device according to claim 7, wherein
the material quality predictor is configured to calculate the material quality as a set of one or more out of tensile strength, yield stress, and ductility of the rolling material as rolled at the set of temperatures of the rolling material calculated at the setting calculator.

9. The optimization device according to claim 1, further comprising
an energy use learner configured to depend on a measure of an electric energy meter or a fuel supply flow meter provided to the rolling mill, to calculate an amount of energy used for services of the rolling mill to mill the rolling material, as an actual use of energy, and depend on the actual use of energy as calculated, to correct a use of energy calculated at the energy use calculator.

10. The optimization device according to claim 3, further comprising
an energy use learner configured to depend on a measure of an electric energy meter or a fuel supply flow meter provided to the rolling mill, to calculate an amount of energy used for services of the rolling mill to mill the rolling material, as an actual use of energy, and depend on the actual use of energy as calculated, to correct a use of energy calculated at the energy use calculator.

11. An optimization device comprising:
a setting calculator configured to depend on an initial size, an initial temperature, and a target temperature of a rolling material, to calculate a control setting value for services of a rolling mill to mill the rolling material;
an energy use calculator configured to depend on the control setting value calculated at the setting calculator, to calculate a use of energy as necessary energy for services of the rolling mill to mill the rolling material;
a manufacturing carbon dioxide emission amount calculator configured to depend on a carbon dioxide emission coefficient and the use of energy calculated at the energy use calculator, to calculate a product carbon dioxide emission amount as an emission amount of carbon dioxide emitted at the rolling mill,
a reference life cycle memory configured to store therein, for each type of associated rolling materials, a reference life cycle as combination of a condition of use for an associated rolling material to be used after shipment, and an amount of carbon dioxide to be emitted in a life cycle thereof including a shipment followed by a collection and a re-milling at the rolling mill, as associated with each other;
a product life cycle carbon dioxide emission amount calculator configured to depend on the reference life cycle, to calculate a product life cycle carbon dioxide emission amount as an amount of carbon dioxide emitted in a life cycle of the rolling material manufactured on a basis of the control setting value calculated at the setting calculator ; and
a carbon dioxide emission amount renderer configured to render on a display the product carbon dioxide emission amount and the product life cycle carbon dioxide emission amount.
